(19) United States
(12) Patent Application Publication
(10) Pub. No.: US 2016/0285099 A1
(43) Pub. Date: Sep. 29, 2016

(54) SOLID MATERIAL-/GEL ELECTROLYTE ACCUMULATOR WITH BINDER OF INORGANIC-ORGANIC HYBRID POLYMER AND METHOD FOR THE PRODUCTION THEREOF

(71) Applicant: FRAUNHOFER-GESELLSCHAFT ZUR FÖRDERUNG DER ANGEWANDTEN FORSCHUNG E.V., München (DE)

(72) Inventors: Jochen SCHULZ, Veitshöchheim (DE); Jochen UEBE, Würzburg (DE); Andreas BITTNER, Randersacker (DE); Uwe GUNTOW, Würzburg (DE); Birke-Elisabeth OLSOWSKI, Veitshöchheim (DE)

(73) Assignee: FRAUNHOFER-GESELLSCHAFT ZUR FÖRDERUNG DER ANGEWANDTEN FORSCHUNG E.V., München (DE)

(21) Appl. No.: 14/442,636

(22) PCT Filed: Nov. 19, 2013
(86) PCT No.: PCT/EP2013/074162

§ 371 Date: May 13, 2015

(30) Foreign Application Priority Data
Nov. 19, 2012 (DE) 10 2012 022 607.1

(51) Int. Cl. H01M 4/62; H01M 10/056; H01M 10/0525; H01G 11/56; H01G 11/84

(52) U.S. Cl. CPC H01M 4/622; H01G 11/56; H01G 11/84; H01M 4/625; H01M 10/0525; H01M 10/056

(57) ABSTRACT

The present invention relates to a lithium accumulator or a combination thereof with a double-layer capacitor which is distinguished by a solid material- or gel electrolyte and a binder made of inorganic-organic hybrid polymer. By means of the new binder concept presented here, it is possible to revolutionise the contacting of the individual components in these accumulators and thus to enable a fundamental improvement in the ion transport. Associated therewith is a new, fast, simple and flexible production method for lithium accumulators which optimises these with respect to safety, stability, environmental friendliness and efficiency.

The present invention relates to a lithium accumulator or the combination thereof with a double-layer capacitor which is distinguished by a solid material- or gel electrolyte and a binder made of inorganic-organic hybrid polymer. By means of the new binder concept presented here, it is possible to revolutionise the contacting of the individual components in these accumulators and thus to enable a fundamental improvement in the ion transport. Associated therewith is a new, fast, simple and flexible production method for lithium accumulators which optimises these with respect to safety, stability, environmental friendliness and efficiency.

The transport of lithium ions through the electrodes of the most different of variants of rechargeable lithium batteries—in addition to conductivity of the active materials themselves—has been made possible to date above all by the adjustment of a specific porosity and a liquid electrolyte which infiltrates these pores.

The problem with these electrolytes is that the solvents, such as DEC, DMC, EMC, impair the safety of the accumulators due to their easy inflammability.

In addition, these electrolytes interact greatly with the electrode active material, which leads to degradation of the battery and a loss of storage capacity.

One possibility for effecting an improvement in the safety of batteries is the use of non-combustible solid material electrolytes. Since infiltration of electrode pores with such electrolytes is however no longer possible, this leads to more difficult ion transport through the electrodes. This causes an increased resistance and consequently a reduction in power density of the accumulators.

A further problem of such solid material electrolytes is the contacting with the electrodes. Thus the coating thereof with an active material layer leads to undesired reactions during production. The combination with electrodes applied on current conductors is made difficult, on the one hand, by the poor cohesion and, on the other hand, by contact being merely at points.

The object of the present invention was hence the provision of an accumulator with a solid electrolyte which enables contacting of the electrodes with the solid electrolyte which is improved relative to the state of the art.

The object is achieved by the lithium accumulator according to claim 1, the method for the production of a lithium accumulator according to claim 14 and the use of an inorganic-organic hybrid polymer according to claim 21. The dependent claims represent preferred embodiments of the invention.

According to the invention, a lithium accumulator is hence provided, comprising
a) at least two electrodes, at least one electrode comprising a material selected from the group consisting of lithium-intercalating/-deintercalating substances and electrically conductive substances, and also mixtures thereof;
b) at least one solid material- or gel electrolyte which is disposed between the at least two electrodes; and
c) at least one Li-ion-conducting binder with or without lithium salt which contacts the electrode material and/or the solid material- or gel electrolyte.

The accumulator is characterised in that the binder comprises a lithium-ion-conductive, inorganic-organic hybrid polymer or consists thereof.

The novelty of the invention is therefore a lithium-ion-conductive hybrid polymer material which surprisingly has the additional property of a bonding effect. Via the combination of inorganic and organic regions of the hybrid polymer, the most varied of functionalities can be produced and hence the properties of the hybrid polymer can be adjusted specifically. Hence the binder can be coordinated to specific electrodes and solid material electrolytes and an optimum of electrical and ionic conductivity and bonding effect can be achieved.

The high temperature capacity and stability of a hybrid polymer binder relative to reactions with the active materials and/or electrolyte materials (e.g. solid body electrolyte materials) ensures in addition greater safety relative to rechargeable lithium batteries and/or double-layer capacitors from the state of the art.

Furthermore, a binder made of hybrid polymer—in contrast to the materials used in prior art, such as PVDF and NMP—is distinguished by being environmentally friendly and not health-endangering (F-free binder, no health-endangering solvents required).

In addition, such a high bonding effect can be achieved by the hybrid polymer binder that the use of passive material which serves exclusively for the purpose of bonding can be eliminated. In addition to economic advantages, in addition a weight saving is consequently achieved.

A binder made of hybrid polymer is distinguished, furthermore, by the particular property of good lithium-ion conductivity. In a preferred embodiment, the lithium-ion accumulator according to the invention is characterised in that the binder comprises lithium salt and has an ionic conductivity of ≧10⁻⁴ S/cm, optionally 10⁻⁴ to 10⁻³ S/cm, preferably >10⁻⁴ S/cm, particularly preferred ≧10⁻³ S/cm.

The ionic conductivity of the inorganic-organic polymer binder is very high above all when Si—O—Li bonds or Si—O—Li⁺ bonds are contained in the inorganic-oxidic framework thereof. Preferably, the inorganic regions of the hybrid polymer have therefore Si—O—Li bonds. In addition, oxidic heteroatoms selected from the group consisting of B, Zr, Al, Ti, Ge, P, As, Mg, Ca, Cr and W can be incorporated therein.

Furthermore, the polymer can comprise organic substituents (primarily bonded to Si) of vinyl, alkyl, acryl, methacryl, epoxy, PEG, aryl, styryl, (per)fluoroalkyl, (per)fluoroaryl, nitrile, isocyanate or organic carbonates. In particular, vinyl-, allyl-, acryl-, methacryl-, styrene-, epoxy- or cyanurate functionalities can be used for hardening the prepolymer (i.e. for constructing the organic network). With the organic modification, in addition material properties, such as for example thermal, mechanical and electrical properties, can be adjusted specifically.

The binder can comprise in addition a lithium salt, preferably selected from the group consisting of LiCl₄O₄, LiAlO₄, LiAlCl₄₄, LiPF₆, LiSiF₆, LiBF₄, LiBr, LiI, LiSCN, LiSbF₆, LiAsF₆, LiTfa, LiDFOB, LiBOB, LiTFSI, LiCF₃SO₃, LiC₄F₉SO₃, LiN(CF₃SO₂)₂, LiN(C₂F₅SO₂)₂, LiC(CF₃SO₂)₃, LiC(C₂F₅SO₂)₃, as a result of which the ionic conductivity can be further increased.

In order to improve the electrical conductivity, the binder can comprise metallically conducting or semiconducting additives, in particular graphites, graphenes and CNTs.

Preferably, the electrode material of at least one electrode is selected from the group consisting of carbons, alloys of Si, Li, Ge, Sn, Al, Sb, etc., Li₄Ti₅O₁₂, Li_{4-y}A_{y}Ti₅₋ₓMₓO₁₂ (A=Mg, Ca, Al; M=Ge, Fe, Co, Ni, Mn, Cr, Zr, Mo, V, Ta or a combination thereof), Li(Ni,Co,Mn)O₂, Li₁₊ₓ(M,N)₁₋ₓO₂ (M=Mn, Co, Ni or a combination thereof; N═Al, Ti, Fe, Cr, Zr, Mo, V, Ta, Mg, Zn, Ga, B, Ca, Ce, Y, Nb, Sr, Ba, Cd or a combination thereof), (Li,A)ₓ(M,N)_{z}O_{v-w}X_{w} (A=alkali-, alkaline earth metal, lanthanoide or a combination thereof; M=Mn, Co, Ni or a combination thereof; N═Al, Ti, Fe, Cr, Zr, Mo, V, Ta, Mg, Zn, Ga, B, Ca, Ce, Y, Nb, Sr, Ba, Cd or a combination thereof; X═F, Si), LiFePO₄, (Li,A)(M,B)PO₄ (A or B=alkali-, alkaline earth metal, lanthanoide or a combination thereof; M=Fe, Co, Mn, Ni, Ti, Cu, Zn, Cr or a combination thereof), LiVPO₄F, (Li,A)₂(M,B)PO₄F (A or B=alkali-, alkaline earth metal, lanthanoide or a combination thereof; M=Fe, Co, Mn, Ni, Ti, Cu or a combination thereof), Li₃V₂PO₄, Li(Mn,Ni)₂O₄, Li₁₊ₓ(M,N)₂₋ₓO₄ (M=Mn; N═Co, Ni, Fe, Al, Ti, Cr, Zr, Mo, V, Ta or a combination thereof) and mixtures or combinations of the same.

The solid material electrolyte can comprise Li-ion-conducting solid materials or consist thereof and/or the gel electrolyte can comprise Li-ion-conducting gels or consist thereof.

The hybrid polymer binder concerns a stable and simultaneously elastic material, as a result of which basically Li-ion accumulators with both high stability and high elasticity can be provided. It is hence particularly suitable for materials with high volume expansion, such as e.g. Si (expansion: 300%-400%).

Furthermore, it is possible for the first time with a hybrid polymer binder to produce an entirely novel type of electrolyte. This consists of solid material electrolyte particles (e.g. made of lithium-ion-conducting glasses) and is in turn bonded by the lithium-ion-conducting binder.

There is understood according to the invention by the term “particulate” or the term “particle”, not only round bodies but for example also bodies in the form of leaves, bars, wires and/or fibres.

By means of the present invention, it is possible for the first time to provide a novel lithium accumulator which consists entirely of particles between current conductors which are bonded completely by one and the same lithium-ion-conducting hybrid polymer binder. As a result, very high flexibility of the accumulator elements can be achieved, which causes high stability of the accumulator relative to mechanical stress and also with respect to particle expansion/-contraction due to ion-intercalation/-deintercalation.

A preferred embodiment of the accumulator is therefore characterised in that the electrode material and/or the solid material electrolyte comprises particles or consists thereof, preferably particles with a particle size of 10 nm to 100 μm.

At least one electrode of the Li-ion accumulator can comprise no or at least one current conductor.

At least one electrode, one solid body electrolyte, one gel electrolyte and/or one liquid electrolyte can comprise at least one lithium salt, preferably a lithium salt selected from the group consisting of LiCl₄O₄, LiAlO₄, LiAlCl₄4, LiPF₆, LiSiF₆, LiBF₄, LiBr, LiI, LiSCN, LiSbF₆, LiAsF₆, LiTfa, LiDFOB, LiBOB, LiTFSI, LiCF₃SO₃, LiC₄F₉SO₃, LiN(CF₃SO₂)₂, LiN(C₂F₅SO₂)₂, LiC(CF₃SO₂)₃, LiC(C₂F₅SO₂)₃.

Furthermore, the Li-ion-conducting binder can
a) degrade thermally only above 300° C.;
b) have a modulus of elasticity of 10 kPa to 100 MPa, preferably 10 kPa to 1 MPa; and/or
c) have an electrochemical stability, measured relative to Pt and with LiPF₆ and with LiCl₄O₄ and also relative to Li(Mn,Ni)₂O₄ and with LiPF₆, up to above 5 V vs. Li/Li⁺.

In a further preferred embodiment, the rechargeable lithium battery has at least one double-layer capacitor.

Furthermore, the lithium battery can comprise a liquid electrolyte, the liquid electrolyte preferably comprising an Li-ion-conducting liquid, particularly preferred a liquid comprising a lithium salt, in particular a liquid comprising a lithium salt selected from the group consisting of LiCl₄O₄, LiAlO₄, LiAlCl₄, LiPF₆, LiSiF₆, LiBF₄, LiBr, LiI, LiSCN, LiSbF₆, LiAsF₆, LiTfa, LiDFOB, LiBOB, LiTFSI, LiCF₃SO₃, LiC₄F₉SO₃, LiN(CF₃SO₂)₂, LiN(C₂F₅SO₂)₂, LiC(CF₃SO₂)₃, LiC(C₂F₅SO₂)₃ or consisting thereof. Optionally, the liquid electrolyte contacts the Li-ion-conducting binder.

According to the invention, a method for the production of a lithium accumulator is also provided, in which
a) a sol made of an organically modified, polysiloxane-containing material is provided and is mixed with material, selected from the group consisting of lithium-intercalating/-deintercalating substances, electrically conductive substances and solid material electrolyte material and possibly is mixed with at least one organic solvent,
b) the organic solvent is separated, material with a coating made of binder being produced;
c) the material which now has a coating made of binder is isolated, dried and hardened; and
d) the coating material is compressed to form at least one electrode- and/or electrolyte layer or is processed with at least one solvent as paste and is processed to form at least one electrode- and/or electrolyte layer, and
e) at least one solid material electrolyte and/or gel electrolyte is disposed between the at least one and at least one further electrode, respectively with or without current conductor, and optionally at least one liquid electrolyte is added so that the electrolyte contacts the at least two electrodes.

There should be understood by a sol, a colloidal dispersion in a solvent.

The method according to the invention has the advantage that it is simple and economical.

The method can be characterised in that, in step a), in addition at least one lithium salt, preferably selected from the group consisting of LiCl₄O₄, LiAlO₄, LiAlCl₄4, LiPF₆, LiSiF₆, LiBF₄, LiBr, LiI, LiSCN, LiSbF₆, LiAsF₆, LiTfa, LiDFOB, LiBOB, LiTFSI, LiCF₃SO₃, LiC₄F₉SO₃, LiN(CF₃SO₂)₂, LiN(C₂F₅SO₂)₂, LiC(CF₃SO₂)₃, LiC(C₂F₅SO₂)₃ is added and/or at least one hardener is added.

The electrode material of at least one electrode is preferably selected from the group consisting of carbons, alloys of Si, Li, Ge, Sn, Al, Sb, etc., Li₄Ti₅O₁₂, Li_{4-y}A_{y}Ti₅₋ₓMₓO₁₂ (A=Mg, Ca, Al; M=Ge, Fe, Co, Ni, Mn, Cr, Zr, Mo, V, Ta or a combination thereof), Li(Ni,Co,Mn)O₂, Li₁₊ₓ(M,N)₁₋ₓO₂ (M=Mn, Co, Ni or a combination thereof; N═Al, Ti, Fe, Cr, Zr, Mo, V, Ta, Mg, Zn, Ga, B, Ca, Ce, Y, Nb, Sr, Ba, Cd or a combination thereof), (Li,A)ₓ(M,N)_{z}O_{v-w}X_{w} (A=alkali-, alkaline earth metal, lanthanoide or a combination thereof; M=Mn, Co, Ni or a combination thereof; N═Al, Ti, Fe, Cr, Zr, Mo, V, Ta, Mg, Zn, Ga, B, Ca, Ce, Y, Nb, Sr, Ba, Cd or a combination thereof; X═F, Si), LiFePO₄, (Li,A)(M,B)PO₄ (A or B=alkali-, alkaline earth metal, lanthanoide or a combination thereof; M=Fe, Co, Mn, Ni, Ti, Cu, Zn, Cr or a combination thereof), LiVPO₄F, (Li,A)₂(M,B)PO₄F (A or B=alkali-, alkaline earth metal, lanthanoide or a combination thereof; M=Fe, Co, Mn, Ni, Ti, Cu or a combination thereof), Li₃V₂PO₄, Li(Mn,Ni)₂O₄, Li₁₊ₓ(M,N)₂₋ₓO₄ (M=Mn; N═Co, Ni, Fe, Al, Ti, Cr, Zr, Mo, V, Ta or a combination thereof) and mixtures or combinations of the same.

In a further preferred embodiment, the solid body electrolyte comprises Li-ion-conducting solid materials or consists thereof, in particular Li-ion-conducting glasses, and/or the gel electrolyte comprises Li-ion-conducting gels or consists thereof, in particular Li-ion-conducting hybrid polymers, and/or the liquid electrolyte comprises Li-ion-conducting liquids or consists thereof.

In a particularly preferred embodiment, the electrode material and/or the solid material electrolyte comprises particles or consists thereof, preferably particles with a particle size of 10 nm to 100 μm.

The organic solvent can be selected from the group consisting of organic solvents which dissolve the organically modified, polysiloxane-containing material.

The method according to the invention can furthermore be characterised in that
a) drying takes place at temperature of 30 to 50° C., for 20 to 40 min; and/or
b) hardening takes place at a temperature of 70 to 150° C. for 0.5 to 5 hours.

The method according to the invention is used preferably for the production of the rechargeable lithium battery according to the invention.

As a result of the possibility of variable adjustment of the properties via the ratio of inorganic material to organic material or the different functional groups, adaptation to the most varied purposes of use is possible. One such purpose of use would be for example the use of the new material as conductive adhesive.

According to the invention, the use of an inorganic-organic hybrid polymer as binder in a lithium accumulator and/or double-layer capacitor and/or as conductive adhesive is therefore proposed.

The subject according to the invention is intended to be explained in more detail with reference to the subsequent example and the Figures without wishing to restrict said subject to the specific embodiments illustrated here.

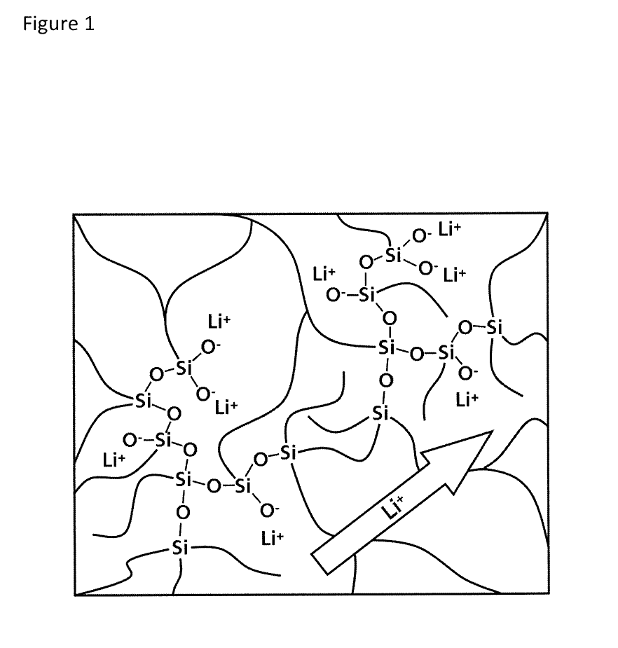

FIG. 1 shows the basic structure of an Li⁺-conductive hybrid polymer. The curved lines represent organic side chains. These are either crosslinked (=organic polymer) or freely moveable.

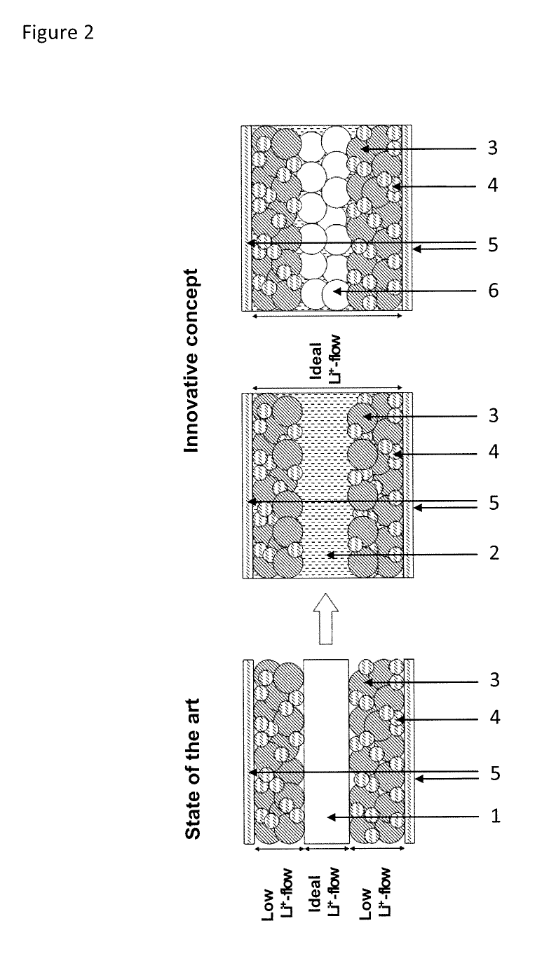

FIG. 2 shows the improved battery principle due to the Li⁺-conductive hybrid polymer binder. In the prior art, it is normal to dispose an Li⁺-conducting solid material 1 between the two electrodes, which consist respectively of active material 3 and conductive carbon black 4 on a current conductor 5. According to the invention, an Li⁺-conducting inorganic-organic hybrid polymer 2 is disposed between the active material 3 and the conducive carbon black 4 of the two electrodes, which hybrid polymer ensures a high Li⁺ flow over the entire space between the two electrodes and through the electrodes. Of course, also another Li⁺-conducting solid material 1 can be disposed here between the two electrodes. It is crucial that the inorganic-organic hybrid polymer 2 substantially improves the contacting between the active material 3, the conductive carbon black 4 and the Li⁺-conducting solid material. In a further preferred embodiment, a solid material electrolyte 6 which consists of Li⁺-conducting particles is disposed between the electrodes in addition to the inorganic-organic hybrid polymer 2.

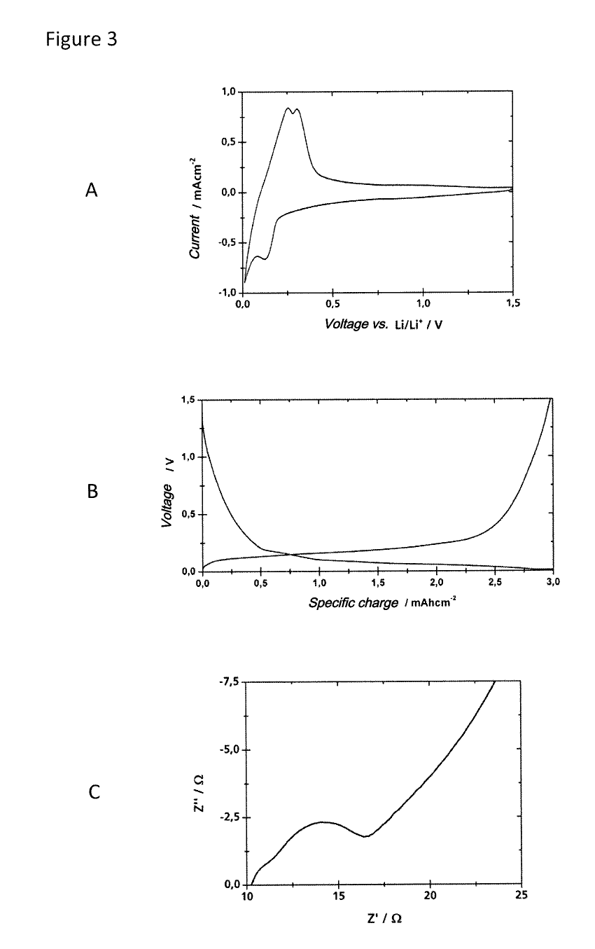

FIG. 3 shows the cyclic voltammogram (A), the charging-/discharging curves (B) and the impedance measurement (C) of an anode which is produced with Li⁺-conductive hybrid polymer and comprises graphite and conductive carbon black, measured with LiPF₆ electrolyte relative to Li/Li⁺.

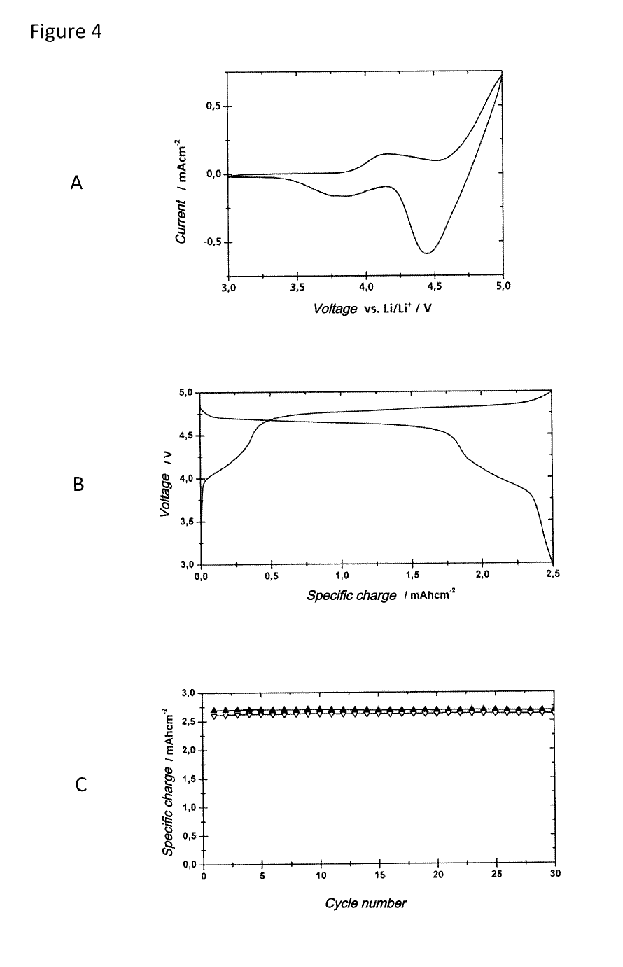

FIG. 4 shows the cyclic voltammogram (A), the charging-/discharging curves (B) and the stable cyclic strength measurement (C) of a cathode which is produced with Li⁺-conductive hybrid polymer and comprises Li(Mn,Ni)₂O₄ and conductive carbon black, measured with LiPF₆-electrolyte relative to Li/Li⁺.

### EXAMPLE

### Production of a Lithium Accumulator with Hybrid Polymer

Step 1: Synthesis of an Li⁺-Conductive Hybrid Polymer Binder

In a 250 ml flask, 152 g (0.29 mol) of 2-methoxypolyethylene oxypropyl trimethoxysilane is agitated with 2.634 g lithium hydroxide (mixture 1).

In parallel, 23.6 g (0.1 mol) of 3-glycidyloxypropyl trimethoxysilane with 140 g of diethylcarbonate is weighed into a 100 ml flask, to which 2.7 g (0.15 mol) of distilled water is added (mixture 2). The mixture is agitated.

After reaching the clear point of mixture 2, the homogeneous mixture 1 is added to this.

After a few days, the solvent is centrifuged off at 40° C. and 28 mbar.

Step 2: Coating of Battery Material with the Hybrid Polymer Binder

In a 1 l flask, 30 g of battery material particles (e.g. Li(Ni,Co,Mn)O₂ particles) is weighed in under argon. Subsequently, 400 g of dimethylcarbonate and 3 g of hybrid polymer binder from step 1 (optionally with lithium salt or 0.03 g of boron trifluoride ethylamine complex) is weighed in.

The flask is agitated slowly on the rotational evaporator rinsed with argon.

After approx. 30 min, centrifugation at 40° C. is begun up to 12 mbar.

Finally, the temperature is increased to 80° C. and centrifugation takes place for 1 hour under these conditions.

The resulting, coated particles can be stored over a long period.

Step 3: Production of Electrodes, Electrolytes and Accumulators

The active material coated with hybrid polymer binder and/or the conductive additive from step 2 coated with hybrid polymer binder is compressed without further pre- or post-treatment on aluminium or copper, as a result of which an electrode (anode or cathode) is produced for an Li-ion accumulator.

In order to produce an Li-ion accumulator, the electrode (cathode, comprising e.g. Li(Ni,Co,Mn)O₂, LiMn_{1.6}Ni_{0.4}O₄, carbon or mixture of the same) is compressed with a further electrode (anode comprising e.g. Li₄Ti₅O₁₂, silicon, carbon or mixtures of the same) and a solid material electrolyte, the solid material electrolyte being disposed between the two electrodes. Particulate solid material electrolytes crosslinked with hybrid polymer binder are hereby particularly advantageous since they provide the Li⁺-ion accumulators with high mechanical flexibility. Likewise advantageous is the use of the hybrid polymer binder as gel electrolyte, hardened between the electrodes.

In a further embodiment, an electrode paste is applied on a current conductor (copper or aluminium) via the established electrode production methods, knife-coating or compression. The paste thereby consists of electrode material coated with hybrid polymer binder (anode, comprising e.g. Li₄Ti₅O₁₂, silicon, graphite, conductive carbon black or mixtures of the same; cathode, comprising e.g. Li(Ni,Co,Mn)O₂, LiMn_{1.6}Ni_{0.4}O₄, conductive carbon black or mixtures of the same), dissolved in at least one solvent. Via the screen printing- or knife-coating method, in addition electrolytes or electrolyte layers, consisting of solid material electrolyte particles crosslinked with hybrid polymer binder are produced. The various layer elements are dried and applied on each other in the sequence, current conductor-anode-electrolyte-cathode-current conductor.

1. A rechargeable lithium battery, comprising
a) at least two electrodes, at least one of said two electrodes comprising a material selected from the group consisting of lithium-intercalating/-deintercalating substances and electrically conductive substances, and mixtures thereof;
b) at least one solid material- and/or gel electrolyte which is disposed between the at least two electrodes; and
c) at least one Li-ion-conducting binder with or without lithium salt which contacts the electrode material and/or the solid material- and/or gel electrolyte, wherein the binder comprises a lithium-ion-conductive,
inorganic-organic hybrid polymer, the solid material electrolyte consisting of particles which comprise Li-ion-conducting solid materials, and the gel electrolyte comprising Li-ion-conducting gels, and the electrode material comprising particles.

2. (canceled)

3. The rechargeable lithium battery according to claim 1, wherein the binder
i) comprises a lithium salt, and/or
ii) comprises metallically conducting or semiconducting additives for improving the electrical conductivity; and/or
iii) degrades thermally only above 300° C.; and/or
iv) has a modulus of elasticity of 10 kPa to 100 MPa; and/or
v) has an electrochemical stability, measured relative to Pt and with LiCl₄O₄ and with LiPF₆, and also relative to Li(Mn,Ni)₇O₄ and with LiPF₆, up to above 5 V vs. Li/Li⁺.

4. The rechargeable lithium battery according to claim 1, wherein the inorganic-organic hybrid polymer comprises an inorganic-oxidic framework consisting of Si—O—Si bonds, this framework comprising optionally in addition
a) oxidic heteroatoms selected from the group consisting of Li, B, Zr, Al, Ti, Ge, P, As, Mg, Ca, Cr and W; and/or
b) organic substituents of vinyl, alkyl, acryl, methacryl, epoxy, PEG, aryl, styryl, (per)fluoroalkyl, (per)fluoroaryl, nitrile, isocyanate or organic carbonates and/or vinyl-, allyl-, acryl-, methacryl-, styrene-, epoxy- or cyanurate functionalities.

5. (canceled)

6. The rechargeable lithium battery according to claim 1, wherein the electrode material of at least one of said at least two electrode is selected from the group consisting of carbons, alloys of Si, Li, Ge, Sn, Al, Sb, etc., Li₄Ti₅O₁₂, Li_{4-y}A_{y}Ti₅₋ₓMₓO₁₂ wherein A=Mg, Ca, Al; M=Ge, Fe, Co, Ni, Mn, Cr, Zr, Mo, V, Ta or a combination thereof, Li(Ni,Co,Mn)O₂, Li₁₊ₓ(M,N)₁₋ₓO₂ wherein M=Mn, Co, Ni or a combination thereof; N═Al, Ti, Fe, Cr, Zr, Mo, V, Ta, Mg, Zn, Ga, B, Ca, Ce, Y, Nb, Sr, Ba, Cd or a combination thereof, (Li,A)ₓ(M,N)_{z}O_{v-w}X_{w} wherein A=alkali, alkaline earth metal, lanthanoide or a combination thereof; M=Mn, Co, Ni or a combination thereof; N═Al, Ti, Fe, Cr, Zr, Mo, V, Ta, Mg, Zn, Ga, B, Ca, Ce, Y, Nb, Sr, Ba, Cd or a combination thereof; X═F, Si, LiFePO₄, (Li,A)(M,B)PO₄ wherein A or B=alkali-, alkaline earth metal, lanthanoide or a combination thereof; M=Fe, Co, Mn, Ni, Ti, Cu, Zn, Cr or a combination thereof, LiVPO₄F, (Li,A)₂(M,B)PO₄F wherein A or B=alkali-, alkaline earth metal, lanthanoide or a combination thereof; M=Fe, Co, Mn, Ni, Ti, Cu or a combination thereof, Li₃V₂PO₄, Li(Mn,Ni)₂O₄, Li₁₊ₓ(M,N)₂₋ₓO₄ wherein M=Mn; N═Co, Ni, Fe, Al, Ti, Cr, Zr, Mo, V, Ta or a combination thereof, and mixtures or combinations of the same.

7.-8. (canceled)

9. The rechargeable lithium battery according to claim 1, wherein at least one electrode comprises no or at least one current conductor.

10. The rechargeable lithium battery according to claim 1, wherein at least one of said at least two electrodes and/or at least one solid material- and/or gel electrolyte comprises at least one lithium salt.

11. (canceled)

12. The rechargeable lithium battery according to claim 1, wherein the lithium battery comprises
a) at least one double-layer capacitor; and/or
b) a liquid electrolyte separator.

13. (canceled)

14. A method for the production of a lithium accumulator, in which
a) a sol made of an organically modified, polysiloxane-containing material is provided and is mixed with material, selected from the group consisting of lithium-intercalating/-deintercalating substances, electrically conductive substances and solid material electrolyte material and possibly with at least one organic solvent;
b) the organic solvent is separated, material with a coating made of binder being produced;
c) the material which now has a coating made of binder is isolated, dried and hardened;
d) the coated material is compressed to form at least one electrode- and/or electrolyte layer or is processed with at least one solvent as paste and is processed to form at least one electrode- and/or electrolyte layer, and
e) at least one solid material electrolyte and/or gel electrolyte is disposed between the at least one and at least one further electrode, respectively with or without current conductor, so that the electrolyte contacts the at least two electrodes.

15. The method according to claim 14, wherein, in step a), in addition at least one lithium salt and/or at least one hardener is added.

16. The method according to claim 14, wherein the electrode material of at least one electrode is selected from the group consisting of carbons, alloys of Si, Li, Ge, Sn, Al, Sb, etc., Li₄Ti₅O₁₂, Li_{4-y}A_{y}Ti₅₋ₓMₓO₁₂ wherein A=Mg, Ca, Al; M=Ge, Fe, Co, Ni, Mn, Cr, Zr, Mo, V, Ta or a combination thereof, Li(Ni,Co,Mn)O₂, Li₁₊ₓ(M,N)₁₋ₓO₂ wherein M=Mn, Co, Ni or a combination thereof; N═Al, Ti, Fe, Cr, Zr, Mo, V, Ta, Mg, Zn, Ga, B, Ca, Ce, Y, Nb, Sr, Ba, Cd or a combination thereof, (Li,A)ₓ(M,N)_{z}O_{v-w}X_{w} wherein A=alkali-, alkaline earth metal, lanthanoide or a combination thereof; M=Mn, Co, Ni or a combination thereof; N═Al, Ti, Fe, Cr, Zr, Mo, V, Ta, Mg, Zn, Ga, B, Ca, Ce, Y, Nb, Sr, Ba, Cd or a combination thereof; X═F, Si, LiFePO₄, (Li,A)(M,B)PO₄ wherein A or B=alkali-, alkaline earth metal, lanthanoide or a combination thereof; M=Fe, Co, Mn, Ni, Ti, Cu, Zn, Cr or a combination thereof, LiVPO₄F, (Li,A)₂(M,B)PO₄F wherein A or B=alkali-, alkaline earth metal, lanthanoide or a combination thereof; M=Fe, Co, Mn, Ni, Ti, Cu or a combination thereof, Li₃V₂PO₄, Li(Mn,Ni)₂O₄, Li₁₊ₓ(M,N)₂₋ₓO₄ wherein M=Mn; N═Co, Ni, Fe, Al, Ti, Cr, Zr, Mo, V, Ta or a combination thereof and mixtures or combinations of the same.

17. The method according to claim 14, wherein the solid material electrolyte comprises Li-ion-conducting solid materials and/or the gel electrolyte comprises Li-ion-conducting gels and/or the liquid electrolyte comprises Li-ion-conducting liquids.

18. The method according to claim 14, wherein the electrode material and/or the solid material electrolyte comprises particles.

19. The method according to claim 14, wherein the organic solvent is selected from the group consisting of organic solvents which dissolve the organically modified, polysiloxane-containing material.

20. The method according to claim 14, wherein
a) drying takes place at a temperature of 30 to 50° C. for 20 to 40 min; and/or
b) hardening takes place at a temperature of 70 to 150° C. for 0.5 to 5 hours.

21. (canceled)

22. The rechargeable lithium battery according to claim 3, wherein the lithium salt is selected from the group consisting of LiCl₄O₄, LiAlO₄, LiAlCl₄, LiPF₆, LiBF₄, LiBr, LiI, LiSCN, LiSbF₆, LiAsF₆, LiTfa, LiDFOB, LiBOB, LiTFSI, LiCF₃SO₃, LiC₄F₉SO₃, LiN(CF₃SO₂)₂, LiN(C₂F₅SO₂)₂, LiC(CF₃SO₂)₃, and LiC(C₂F₅SO₂)₃.
